(19) United States
(12) Patent Application Publication
(10) Pub. No.: US 2023/0398431 A1
(43) Pub. Date: Dec. 14, 2023

(54) IMPLEMENTING TRANSLATION ACTION BASED MOTION SENSING GAME

(71) Applicant: Shenzhen Shimi Network Technology Co., Ltd., Shenzhen (CN)

(72) Inventors: Chao GUO, Shenzhen (CN); Yuan YAO, Shenzhen (CN)

(73) Assignee: Shenzhen Shimi Network Technology Co., Ltd., Shenzhen (CN)

(21) Appl. No.: 18/143,091

(22) Filed: May 4, 2023

(30) Foreign Application Priority Data
Jun. 14, 2022 (CN) 202210668427.3

(51) Int. Cl. A63F 13/211; A63F 13/428

(52) U.S. Cl. CPC A63F 13/211; A63F 13/428

(57) ABSTRACT

A method for implementing a translation action based motion sensing game includes: obtaining player's pose data detected by a motion sensing device after a preset translation-type motion sensing game is initiated; determining whether an action completion degree of the player meets a preset criterion based on the player's pose data and a preset translation action determination model; and, if the action completion degree of the player meets the preset criterion, moving a game object based on the player's pose data.

### CROSS-REFERENCE TO RELATED APPLICATION

This application claims the benefit of priority of Chinese Patent Application No. 202210668427.3, filed on Jun. 14, 2022, the contents of which are incorporated by reference as if fully set forth herein in their entirety.

### TECHNICAL FIELD

The present application relates to motion sensing game technologies, and more particularly, to implementation of a translation action based motion sensing game.

### BACKGROUND

An architecture of a motion sensing game is generally a motion sensing architecture based on inertial measurement units (Mils). In playing the game, a player needs to wear a specific IMU device that is capable of detecting the player's motion pose data, and the system can convert the motion pose data into an action instruction that can be recognized by a game program, so that an object in the game can perform an action that is substantially consistent with that of the player.

However, with the IMU architecture, various problems such as gyroscope drift, angle random walk, rate random walk, rate ramp, and the like are prone to occur in the process of playing the game, resulting in low operation accuracy and easy misoperation.

### SUMMARY

In view of the above, an embodiment of the present application provides a method for implementing a translation action based motion sensing game, including:
obtaining player's pose data detected by a motion sensing device after a preset translation-type motion sensing game is initiated;
determining whether an action completion degree of the player meets a preset criterion based on the player's pose data and a preset translation action determination model; and
in response to the action completion degree of the player meeting the preset criterion, moving a game object based on the player's pose data.

Another embodiment of the present application provides a device for implementing a translation action based motion sensing game, including a processor, and a memory storing thereon a program executable by the processor to perform the above method for implementing the translation action based motion sensing game.

Another embodiment of the present application provides a computer-readable storage medium, having stored thereon a program executable by the processor to perform the above method for implementing the translation action based motion sensing game.

### BRIEF DESCRIPTION OF THE DRAWINGS

FIG. 1 is a block diagram of a device for implementing a translation action based motion sensing game according to an embodiment of the present application.

FIG. 2 is a schematic flow diagram of a method for implementing a translation action based motion sensing game according to an embodiment of the present application.

FIG. 3 is a schematic flow diagram of a method for implementing a translation action based motion sensing game according to another embodiment of the present application.

FIG. 4 is a schematic flow diagram of a method for implementing a translation action based motion sensing game according to a further embodiment of the present application.

### DETAILED DESCRIPTION

Some exemplary embodiments of the present application will be described in detail below with reference to the accompanying drawings. These embodiments are provided to assist in understanding of the present application by those skilled in the art, but not intended to limit the present application.

It should be noted that in the claims, any reference signs placed between parentheses shall not be construed as limiting the claim. “Containing” present herein does not exclude elements or steps not listed in the claims. The quantifier “a” or “an” preceding a component does not exclude the existence of more than one such component. The present application may be implemented by means of hardware comprising several distinct components and by means of a suitably programmed computer. In the unit claims enumerating several means, several of these means may be specifically embodied by the same item of hardware. The use of “first”, “second”, and “third”, etc. does not indicate any order and can be interpreted as names.

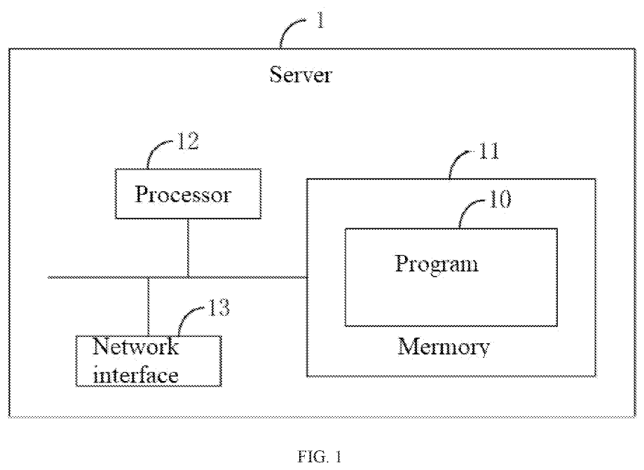

As shown in FIG. 1, which is a block diagram of a server 1 (also called translation action based motion sensing game device) in a hardware operating environment involved in an embodiment of the present application.

The server of the embodiment of the present application can be a device having a display function, such as, “an Internet of Things device”, an Augmented Reality (AR)/Virtual Reality (VR) device with a networking function, an intelligent sound box, autonomous vehicles, a tablet computer, an electronic book reader, or the like.

As shown in FIG. 1, the server 1 includes a memory 11, a processor 12, and a network interface 13.

The memory 11 includes at least one type of readable storage medium including a flash memory, a hard disk, a multimedia card, a card-type memory (for example, an SD or DX memory), a magnetic memory, a magnetic disk, an optical disk, or the like. In some embodiments, the memory 11 may be an internal storage unit of the server 1, such as a hard disk of the server 1. In other embodiments, the memory 11 may also be an external storage device of the server 1, such as a plug-in hard disk, a Smart Media Card (SMC), a Secure Digital (SD) card, a Flash Card, or the like provided on the server 1.

Further, the memory 11 may also include an internal storage unit of the server 1 as well as an external storage device. The memory 11 may be used to not only store the application software installed in the server 1 and various types of data, such as codes of the translation action based motion sensing game program 10, but also temporarily store data that has been output or to be output.

In some embodiments, the processor 12 may be a Central Processing Unit (CPU), a controller, a microcontroller, a microprocessor or other data processing chip for running program codes or processing data stored in the memory 11, such as executing a translation action based motion sensing game program 10 or the like.

The network interface 13 may optionally include a standard wired interface and a wireless interface (e.g., a WIFI interface), typically used to establish a communication connection between the server 1 and other electronic devices.

The network may be an Internet, a cloud network, a Wi-Fi network, a personal network (PAN), a local area network (LAN), and/or a metropolitan area network (MAN). Various devices in a network environment may be configured to be connected to a communication network in accordance with various wired and wireless communication protocols. Examples of such wired and wireless communication protocols may include, but not be limited to, at least one of Transmission Control Protocol and Internet Protocol (TCP/IP), User Datagram Protocol (UDP), Hypertext Transfer Protocol (HTTP), File Transfer Protocol (FTP), ZigBee, EDGE, IEEE 802.11, Wi-Fi, 802.16, IEEE 802.11s, IEEE 802.11g, multi-hop communication, wireless access point (AP), device-to-device communication, cellular communication protocol, and/or Bluetooth communication protocol, or combinations thereof.

Alternatively, the server may also include a user interface, which may include a display, an input unit such as a Keyboard, and an optional user interface may also include a standard wired interface and a wireless interface. Alternatively, in some embodiments, the display may be an LED display, a liquid crystal display, a touch-sensitive liquid crystal display, an Organic Light Emitting Diode (OLED) touch device, or the like. The display may also be referred to as a display screen or a display unit for displaying information processed in the server 1 and for displaying a user interface for visualization.

FIG. 1 shows only a server 1 having components 1113 and a program (for example, a translation action based motion sensing game program) 10, it should be understood by those skilled in the art that the structure shown in FIG. 1 does not constitute a limitation on the server 1, and may include fewer or more components than shown, or some combination of components, or different arrangements of components.

In an embodiment, the processor 12 may be used to call the program stored in the memory 11 to perform the following operations: obtaining player's pose data detected by a motion sensing device after a preset translation-type motion sensing game is initiated; determining whether an action completion degree of the player meets a preset criterion according to the player's pose data and a preset translation action determination model; and in response to the action completion degree of the player meeting the preset criterion, moving a game object based on the player's pose data.

In an embodiment, the processor 12 may be used to call the program stored in the memory 11 to perform the following operations: calculating a target offset value of a game object from the player's pose data; and inputting the target offset value into the preset translation action determination model to determine whether the action completion degree of the player meets the preset criterion.

In an embodiment, the processor 12 may be used to call the program stored in the memory 11 to perform the following operations: calling a preset callback function to convert the player's pose data into a target game coordinate; obtaining a current game coordinate of the game object based on the callback function; and calculating the target offset value according to the target game coordinate, the current game coordinate, and a preset scaling ratio.

In an embodiment, the processor 12 may be used to call the program stored in the memory 11 to perform the following operations: using x-axis data and y-axis data of the three-axis gyroscope data and the three-axis acceleration data to calculate the target game coordinate.

In an embodiment, the processor 12 may be used to call the program stored in the memory 11 to perform the following operations:
constructing and training the translation action determination model based on a logistic regression algorithm, where an objective function for the translation action determination model is as follows:

$${h}_{W} ( x ) = g ( {W}^{T} x ) = \frac{I}{I + {e}^{- {w}^{T} x}} ,$$

where h_{W}(x) outputs a probability that the current offset value meets a preset criterion; x=(x₀, x₁, . . . , xₙ) is an argument representing an offset value; w^{T}=(w₀, w₁, . . . , wₙ)^{T} is a parameter of the argument (x); and
a loss function for the translation action determination model is as follows:

$${J}_{log} ( w ) = {\sum }_{i = 1}^{m} \{ - {y}_{i} Log ( p ( {x}_{i} ; w ) ) - ( 1 - {y}_{i} ) Log ( 1 - p ( {x}_{i} ; w ) ) \} ,$$

where p(xᵢ;w) represents a probability that the argument xᵢ is predicted to be positive, 1−p(xᵢ;w) represents a probability that the argument xᵢ is predicted to be negative, m indicates a number of samples of the argument x, and yᵢ indicates a value of the argument xᵢ in a y-axis of a two-dimensional plane.

In an embodiment, the processor 12 may be used to call the program stored in the memory 11 to perform the following operations: setting a critical value of the translation action determination model according to a height of a current player.

In an embodiment, the processor 12 may be used to call the program stored in the memory 11 to perform the following operations: calculating the target offset value according to the target game coordinate, the current game coordinate, and the preset scaling ratio if the target game coordinate is greater than a game boundary coordinate.

In an embodiment, the processor 12 may be used to call the program stored in the memory 11 to perform the following operations: moving the game object according to a rendering frame rate of the game and the target offset value.

Based on a hardware architecture of the device for implementing a translation action based motion sensing game described above, an embodiment of the method for implementing a translation action based motion sensing game of the present application is proposed. The method for implementing the translation action based motion sensing game of the present application aims to improve the operation accuracy of the translation action based motion sensing game.

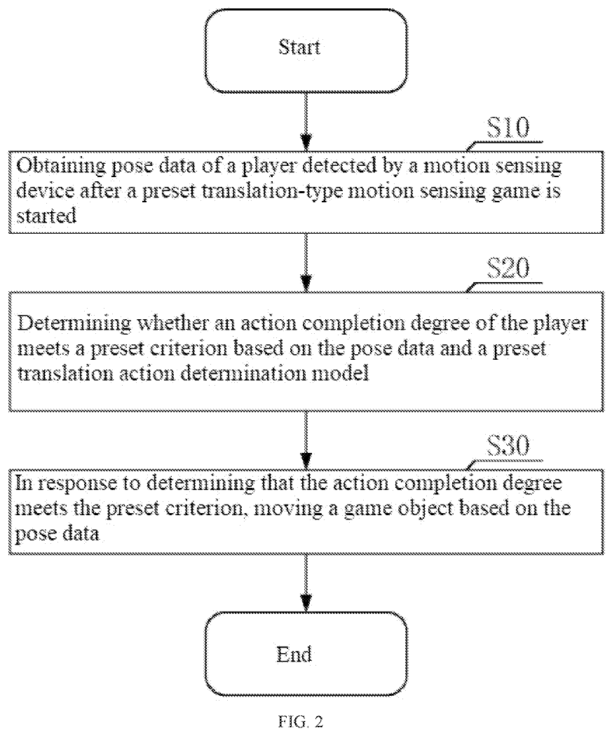

Referring to FIG. 2, which is a flow diagram of an embodiment of a method for implementing a translation action based motion sensing game of the present application. The method for implementing a translation action based motion sensing game includes the following steps.

At Step S10, player's pose data detected by a motion sensing device is obtained after a preset translation-type motion sensing game is initiated.

The preset translation-type motion sensing game refers to a game in which a player is required to be moved horizontally in reality for play, where the player's horizontal movement in reality includes, but not limited to, moving the player with the worn motion sensing device, manually controlling the motion sensing device to be moved, or the like. For example, games such as Breakout clone, Sokoban, Army flag, Chinese chess, chess, and Huarong Road all belong to the translation-type game. Accordingly, a corresponding translation-type motion sensing game can be developed based on the translation-type game. Of course, the translation-type motion sensing game is not limited to the above-mentioned types, but may include other games. Here, no one-by-one example is given, and a game in which a player is required to perform a translation in reality so as to implement a game command may be considered to be the translation-type motion sensing game mentioned in the technical solution of the present application.

Further, a preset jump-type motion sensing game is run on a terminal, which may be a desktop computer, a notebook computer, a game host, a portable game host, a smartphone, a tablet computer, a smartwatch, a smart TV, or the like.

The motion sensing device refers to a device capable of detecting player's pose data. Generally, the motion sensing device is arranged to include a six-axis IMU sensor including a three-axis accelerometer and a three-axis gyroscope, where the six-axis IMU sensor detects the player's pose data by detecting changes in the three-axis acceleration and the three-axis angular velocity of the player. Specifically, the motion sensing device is provided in a wearable form, including, but not limited to, such as a hand ring, a glove watch, a headscarf, a hat, a vest, a fitness ring, a game handle, or the like.

Further, before playing the game, the motion sensing device needs to establish a communication connection with the user terminal, where a wired connection or a wireless connection may be established between the motion sensing device and the terminal. For example, the motion sensing device can establish a wired connection with the user terminal based on at least one of a USB 2.0 protocol, a USB 3.0 protocol, a thunderbolt 3 protocol, and thunderbolt 4 protocol, and the motion sensing device can establish a wireless connection with the user terminal based on at least one of a Bluetooth protocol, a Wi-Fi protocol, an infrared protocol, a 2.4G communication protocol, and a near field communication (NFC) protocol.

At Step S20, it is determined whether an action completion degree of the player meets a preset criterion according to the player's pose data and a preset translation action determination model.

Specifically, after the pose data of the player is detected by the motion sensing device, the motion sensing device can directly transmit the pose data of the player to the user terminal based on the communication protocol. In this way, the amount of calculation and the amount of data transmission of the motion sensing device can be reduced, thereby facilitating the reduction of hardware requirements of the motion sensing device and prolonging the life time of the motion sensing device. In addition, the reduction in the amount of data transmission also contributes to reducing the delay of the motion sensing device to the user terminal to improve the game experience of the player.

Further, after the player's pose data is received by the user terminal, the user terminal can combine the player's pose data and the preset translation action determination model to determine whether the action completion degree of the player meets the preset criterion. The preset translation action determination model is established and trained on the basis of a machine learning algorithm, so as to determine whether a jump action of the player meets the preset criterion. It should be noted that the preset criterion may be set to a fixed value, or may be adaptively adjusted according to different game types or game contents, which is not specifically limited in the present application.

Specifically, the preset translation action determination model may be directly deployed on the user terminal, or may be also deployed on a local server or a cloud server connected to the user terminal.

At Step S30, if the action completion degree of the player meets the preset criterion, a game object is moved based on the player's pose data.

Specifically, after it is determined that the action completion degree of the player meets the preset criterion, the game object can be moved according to the player's pose data. An Euler angle resolution algorithm may be used to perform data resolution on the player's pose data to obtain a player operation instruction, thereby moving the game object. The game object refers to an object that the player needs to move, and the game object can changes accordingly depending on different game types. For example, in a Sokoban game, the game object is a box. For another example, in a Huarong Road game, the game object is a plate drawn with specific characters. For other example, in a Breakout clone game, the game object is a brick board.

Specifically, the player action is determined by the preset translation action determination model. On the one hand, the noise in the player's pose data detected by the motion sensing detection device can be filtered, thereby reducing the misoperation of the player. On the other hand, by setting different preset criterion, the user terminal can determine the action completion degree of the player according to the game type, the game difficulty, and the game checkpoint, thereby greatly improving the operability of the player and improving the game experience of the player.

Of course, if the preset translation action determination model determines that the player translation action does not meet the preset criterion, the user terminal does not convert the player's pose data into a game movement instruction, and naturally, the game object does not make any action.

It can be understood that, according to the method for implementing a translation-based motion sensing game of the present application, the preset translation action determination model is set, so that the game object controlled by the player can be moved only after the motion completion degree of the player meets the preset standard. In this way, not only the probability that the game object is mismoved due to misoperation can be reduced to improve the operation accuracy of the player, but also different preset standards can be provided to adapt to different game requirements, thereby improving the playability of the game. It can be seen that, compared with the conventional motion sensing game method, the method for motion sensing game of the present application has the advantages of higher operation accuracy and better game experience of the player.

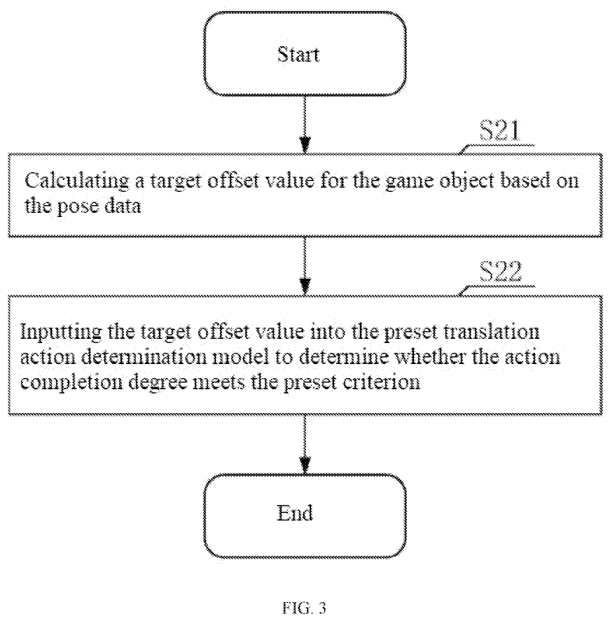

As shown in FIG. 3, in an embodiment, the determining whether an action completion degree of the player meets a preset criterion based on the player's pose data and a preset translation action determination model includes:

S21 of calculating a target offset value of a game object from the player's pose data.

The target offset value refers to a value to be moved by the game object and calculated from the current player's pose data, which is generally composed of a moving direction and a moving distance.

Specifically, after the player's pose data detected by the motion sensing detection device is received, data resolution can be performed on the player's pose data according to the Euler angle resolution algorithm to calculate the value that the game object needs to move under the current player's pose data from the player's pose data.

S22 of inputting the target offset value into the preset translation action determination model to determine whether the action completion degree of the player meets the preset criterion.

Specifically, it is possible to determine the movement distance and the movement direction when the player currently performs the translation action according to the target offset value. Since the translation-type motion sensing game generally requires the player to complete the movement of a preset direction and a preset distance in the plane, it is possible to determine whether the action completion degree of the player meets the preset criterion according to the target offset value.

It should be understood that, by first calculating the target offset value of the game object, and then inputting the target offset value into the preset translation action determination model, the translation action determination model can be simplified to reduce the training cost of the model on the basis of ensuring a determination accuracy of the action completion degree of the player, while the calculation force and calculation time required for the user terminal to determine the action completion degree of the player can be reduced. Of course, the design of the present application is not limited to thereto. In other embodiments, the player's pose data may be directly inputted into a preset translation action determination model to determine the action completion degree of the player.

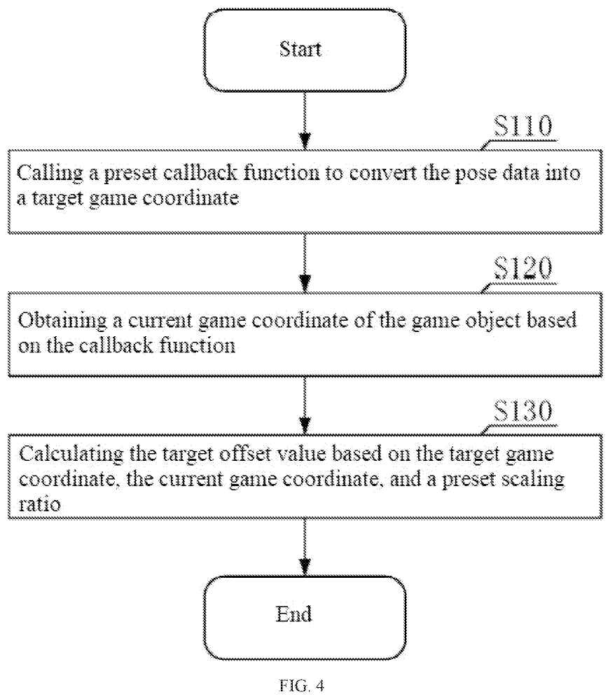

As shown in FIG. 4, in some embodiments, the calculating the target offset value of the game object from the player's pose data includes:

S110 of calling a preset callback function to convert the player's pose data into a target game coordinate.

After the player's pose data is received, an Euler angle resolution algorithm may be called according to the preset callback function to convert the player's pose data into the target game coordinate. The target game coordinate represents a target position to which the game object will be moved and determined according to the current player's pose data.

S120 of obtaining a current game coordinate of the game object based on the callback function.

Specifically, after the callback function is initiated, the user terminal can also read a current game coordinate of the game object from the storage (for example, the hard disk or the memory) according to the incoming callback function. The current game coordinate refers to a coordinate of the game object before it is moved. Each time the game object is moved to the target position, the user terminal records a coordinate of the game object once, and the coordinate recorded before the movement of the game object is the current game coordinate of the game object, so that the coordinate can be directly called. It should be understood that the manner in which the current game coordinate of the game object is obtained by the callback function is not only faster in response, but also requires less computation than the manner in which the current game coordinate of the game object is obtained in real time.

S130 of calculating the target offset value based on the target game coordinate, the current game coordinate, and a preset scaling ratio.

Specifically, the preset scaling ratio is a mapping relationship of a real distance to a game distance. By the preset scaling ratio, it is possible to scale up or down the real distance and the game distance with an equal proportion, so as to ensure synchronization of the real action of the player and the moving distance of the game object, thereby improving the game experience of the player.

Specifically, after the target game coordinate and the current game coordinate are obtained, the target offset value of the game object can be calculated according to the following formula:

Target Offset Value=(Target Game Coordinate−Current Game Coordinate)*Scaling ratio.

It should be understood that, by the above method, the target offset value of the game object can be obtained quickly and with a low calculation amount.

Specifically, the player's pose data includes three-axis gyroscope data and three-axis acceleration data.

Further, x-axis data and y-axis data of the three-axis gyroscope data and the three-axis acceleration data is only used to calculate the target game coordinate. Specifically, the three-axis gyroscope and the three-axis accelerometer each include three coordinate axes: an x-axis, a y-axis, and a z-axis, where the x-axis and the y-axis are used to represent the data of the player in a plane direction (meaning parallel to the ground), and the z-axis is used to represent the data of the player in a vertical direction (meaning perpendicular to the ground). Therefore, only the data of the x-axis and the y-axis is used to calculate the target game coordinate of the game object, so that the calculation accuracy and the calculation speed can be improved while reducing the amount of data.

In some embodiments, the method of the present application further includes, after obtaining the current game coordinate of the game object: calculating the target offset value according to the target game coordinate, the current game coordinate, and the preset scaling ratio if the target game coordinate is greater than a game boundary coordinate.

The game boundary coordinate is used to represent the boundary of the game region, and a game range can be limited by setting the game boundary coordinate so as to limit a movement range of the player.

Specifically, after the target game coordinate is obtained, the target game coordinate and the game boundary coordinate may be compared to determine whether an endpoint position of the game object exceeds the game boundary. If the target game coordinate exceeds the game boundary, the target offset value may be calculated according to the following formula:

Target Offset Value=(Game Boundary Coordinate−Current Game Coordinate)*Scaling Ratio.

It should be understood that, by the above method, when the endpoint position of the game object exceeds the game boundary, the game object can be finally moved to the game boundary while the game object is controlled. As such, the game object can be moved while avoiding the game object beyond the game boundary.

In some embodiments, moving the game object based on the player's pose data includes: moving the game object according to a rendering frame rate of the game and the target offset value.

Specifically, if the action completion degree of the player meets the preset criterion, the game object can be moved according to the target offset value. Moving the game object according to the rendering frame rate of the game is that the terminal display device displays the moved picture of the game object based on the rendering frame rate of the game, thereby avoiding picture tearing and improving the display effect.

In some embodiment, the method of the present application further includes, after inputting the target offset value into the preset translation action determination model:
constructing and training the translation action determination model based on a logistic regression algorithm, where an objective function for the translation action determination model is as follows:

$${h}_{W} ( x ) = g ( {W}^{T} x ) = \frac{I}{I + {e}^{- {w}^{T} x}} ,$$

where h_{W}(x) outputs a probability that the current offset value meets a preset criterion; x=(x₀, x₁, . . . , xₙ) is an argument representing an offset value; w^{T}=(w₀, w₁, . . . , wₙ)^{T} is a parameter of the argument (x); and
a loss function for the translation action determination model is as follows:

$${J}_{log} ( w ) = {\sum }_{i = 1}^{m} \{ - {y}_{i} Log ( p ( {x}_{i} ; w ) ) - ( 1 - {y}_{i} ) Log ( 1 - p ( {x}_{i} ; w ) ) \} ,$$

where p(xᵢ;w) represents a probability that the argument xᵢ is predicted to be positive, 1−p(xᵢ;w) represents a probability that the argument xᵢ is predicted to be negative, m indicates a number of samples of the argument x, and yᵢ indicates a value of the argument xᵢ in a y-axis of a two-dimensional plane.

It should be understood that the logistic regression algorithm is a typical classification algorithm that can calculate the probability that the current variable is a positive example or a negative example. After the probability of the variable is obtained, it can be compared with a preset critical value to determine whether the player's action meets the preset criterion. There is a certain deviation in translation actions of different players, and the purpose of the present application is to determine whether the action completion degree of the player meets the preset criterion. Here, the translation action determination model is constructed by using the logistic regression algorithm, and whether the action of the player meets the preset criterion can be determined on the basis of tolerating a certain action error. Moreover, by setting an appropriate critical value, it is possible to make the determination result more close to an actual scene, so as to obtain a more realistic determination. It should be noted that the translation action determination model constructed by the logistic regression algorithm can not only determine that the translation action with insufficient movement amplitude does not meet the preset criterion, but also can determine that the translation action with too large movement amplitude does not meet the preset criterion.

Of course, the design of the present application is not limited to thereto. In other embodiments, the translation action determination model may be constructed using a model, such as a random forest, a convolution neural network, a depth residual neural network, and K proximity.

In some embodiment, the method of the present application further includes setting a critical value of the translation action determination model according to a height of a current player.

Specifically, the player's step length and arm length can be estimated from the player's height, and then a corresponding critical value can be set according to the player's step length or arm length. It is possible to adaptively select the step length of the player as the critical value reference, or select the arm length of the player as the critical value reference depending on different game types.

It should be understood that, by adaptively setting the critical value of the translation action determination model according to the step length or arm length of the player, the accuracy of the model determination can be further improved, thereby contributing to reducing misoperation of the player and improving the operation accuracy of the player.

In addition, another embodiment of the present application further provides a computer-readable storage medium, which may be any one or any combination of a hard disk, a multimedia card, an SD card, a flash memory card, an SMC, a read-only memory (ROM), an erasable programmable read-only memory (EPROM), a portable compact disk read-only memory (CD-ROM), a USB memory, or the like. The translation action based motion sensing game program 10 is stored in the computer-readable storage medium. A specific embodiment of the computer-readable storage medium of the present application is substantially the same as the specific embodiment of the method for the translation action based motion sensing game program and the server 1, and details thereof are not repeatedly described herein.

It should be appreciated by those skilled in the art that embodiments of the present application may be provided as a method, a system, or a computer program product. Thus, the present application may take the form of a full hardware embodiment, a full software embodiment, or an embodiment incorporating both software and hardware. Moreover, the present application may take the form of a computer program product embodied on one or more computer usable storage media (including, but not limited to, magnetic disk memory, CD-ROM, optical memory, etc.) having computer usable program code embodied therein.

The present application is described with reference to flow diagram and/or block diagram of the method, the device (the system), and the computer program product according to the embodiments of the present application. It should be understood that each flow and/or block in the flow diagram and/or block diagram, and combinations of flow and/or block in the flow diagram and/or block diagram may be implemented by computer program instructions. These computer program instructions may be provided to processors of a general purpose computer, a special purpose computer, an embedded processor, or other programmable data processing device to produce a machine such that the instructions executed by the processor of the computer or other programmable data processing device produce means for implementing the functions specified in one or more flows of the flow diagram and/or one or more blocks of the block diagram.

These computer program instructions may also be stored in a computer-readable memory capable of directing a computer or other programmable data processing apparatus to operate in a particular manner, such that the instructions stored in the computer-readable memory produce an article of manufacture including instruction means that perform the functions specified in one or more flows of the flow diagram and/or one or more blocks of the block diagram.

These computer program instructions may also be loaded onto a computer or other programmable data processing device such that a series of operational steps are performed on the computer or other programmable device to produce a computer-implemented process, such that the instructions that are executed on the computer or other programmable device provide steps for implementing the functions specified in one or more flows of the flow diagram and/or one or more blocks of the block diagram.

Although some embodiments of the present application have been described, those skilled in the art can make various changes and modifications to these embodiments based on the basic inventive concept. Accordingly, the appended claims are intended to be interpreted as including these embodiments and all changes and modifications that fall within the scope of the present application.

What is claimed is:

1. A method for implementing a translation action based motion sensing game, comprising:
obtaining pose data of a player detected by a motion sensing device after a preset translation-type motion sensing game is started;
determining whether an action completion degree of the player meets a preset criterion based on the pose data and a preset translation action determination model; and
in response to determining that the action completion degree meets the preset criterion, moving a game object based on the pose data.

2. The method of claim 1, wherein the determining of whether the action completion degree meets the preset criterion comprises:
calculating a target offset value for the game object based on the pose data; and
inputting the target offset value into the preset translation action determination model to determine whether the action completion degree meets the preset criterion.

3. The method of claim 2, wherein the calculating of the target offset value comprises:
calling a preset callback function to convert the pose data into a target game coordinate;
obtaining a current game coordinate of the game object based on the callback function; and
calculating the target offset value based on the target game coordinate, the current game coordinate, and a preset scaling ratio.

4. The method of claim 3, wherein the pose data comprises three-axis gyroscope data and three-axis acceleration data, and x-axis data and y-axis data of the three-axis gyroscope data and the three-axis acceleration data is used to calculate the target game coordinate.

5. The method of claim 4, wherein
the preset translation action determination model is constructed and trained based on a logistic regression algorithm,
wherein an objective function for the preset translation action determination model is as follows:
$${h}_{W} ( x ) = g ( {W}^{T} x ) = \frac{I}{I + {e}^{- {w}^{T} x}} ,$$
where h_{W}(x) outputs a probability that a current offset value meets a preset criterion, x=(x₀, x₁, . . . , xₙ) is an argument representing an offset value, and w^{T}=(w₀, w₁, . . . , wₙ)^{T} represents a parameter for the argument x, where n indicates a number of samples of the argument x and represents an integer greater than 1; and
a loss function for the preset translation action determination model is as follows:
$${J}_{log} ( w ) = {\sum }_{i = 1}^{m} \{ - {y}_{i} Log ( p ( {x}_{i} ; w ) ) - ( 1 - {y}_{i} ) Log ( 1 - p ( {x}_{i} ; w ) ) \} ,$$
wherein p(xᵢ;w) represents a probability that the argument xᵢ is predicted to be positive, 1−p(xᵢ;w) represents a probability that the argument xᵢ is predicted to be negative, m indicates a number of samples of the argument x, and yᵢ indicates a value of the argument xᵢ in a y-axis of a two-dimensional plane.

6. The method of claim 5, wherein a critical value for the preset translation action determination model is set based on a height of the player.

7. The method of claim 3, wherein the calculating of the target offset value based on the target game coordinate, the current game coordinate, and the preset scaling ratio comprises:
in response to determining that the target game coordinate is greater than a game boundary coordinate, calculating the target offset value based on the game boundary coordinate, the current game coordinate, and the preset scaling ratio.

8. The method of claim 3, wherein the moving of the game object based on the pose data comprises:
moving the game object based on to a rendering frame rate of the game and the target offset value.

9. The method of claim 7, wherein the moving of the game object based on the pose data comprises:
moving the game object based on to a rendering frame rate of the game and the target offset value.

10. A device for implementing a translation action based motion sensing game, comprising a processor, and a memory storing thereon a program executable by the processor to perform operations comprising:
obtaining pose data of a player detected by a motion sensing device after a preset translation-type motion sensing game is started;
determining whether an action completion degree of the player meets a preset criterion based on the pose data and a preset translation action determination model; and
in response to determining that the action completion degree meets the preset criterion, moving a game object based on the pose data.

11. The device of claim 10, wherein the determining of whether the action completion degree meets the preset criterion comprises:
calculating a target offset value for the game object based on the pose data; and
inputting the target offset value into the preset translation action determination model to determine whether the action completion degree meets the preset criterion.

12. The device of claim 11, wherein the calculating of the target offset value comprises:
calling a preset callback function to convert the pose data into a target game coordinate;
obtaining a current game coordinate of the game object based on the callback function; and
calculating the target offset value based on the target game coordinate, the current game coordinate, and a preset scaling ratio.

13. The device of claim 12, wherein the pose data comprises three-axis gyroscope data and three-axis acceleration data, and x-axis data and y-axis data of the three-axis gyroscope data and the three-axis acceleration data is used to calculate the target game coordinate.

14. The device of claim 13, wherein
the preset translation action determination model is constructed and trained based on a logistic regression algorithm,
wherein an objective function for the preset translation action determination model is as follows:
$${h}_{W} ( x ) = g ( {W}^{T} x ) = \frac{I}{I + {e}^{- {w}^{T} x}} ,$$
wherein h_{W}(x) outputs a probability that a current offset value meets a preset criterion, x=(x₀, x₁, . . . , xₙ) is an argument representing an offset value, and w^{T}=(w₀, w₁, . . . , wₙ)^{T}: represents a parameter for the argument x, where n represents an integer greater than 1; and
a loss function for the preset translation action determination model is as follows:
$${J}_{log} ( w ) = {\sum }_{i = 1}^{m} \{ - {y}_{i} Log ( p ( {x}_{i} ; w ) ) - ( 1 - {y}_{i} ) Log ( 1 - p ( {x}_{i} ; w ) ) \} ,$$
wherein p(xᵢ;w) represents a probability that the argument xᵢ is predicted to be positive, 1−p(xᵢ;w) represents a probability that the argument xᵢ is predicted to be negative, m indicates a number of samples of the argument x, and yᵢ indicates a value of the argument xᵢ in a y-axis of a two-dimensional plane.

15. The device of claim 14, wherein a critical value for the preset translation action determination model is set based on a height of the player.

16. A computer-readable storage medium having stored thereon a program executable by a processor to perform operations comprising
obtaining pose data of a player detected by a motion sensing device after a preset translation-type motion sensing game is started;
determining whether an action completion degree of the player meets a preset criterion based on the pose data and a preset translation action determination model; and
in response to determining that the action completion degree meets the preset criterion, moving a game object based on the pose data.

17. The computer-readable storage medium of claim 16, wherein the determining of whether the action completion degree meets the preset criterion comprises:
calculating a target offset value for the game object based on the pose data; and
inputting the target offset value into the preset translation action determination model to determine whether the action completion degree meets the preset criterion.

18. The computer-readable storage medium of claim 17, wherein the calculating of the target offset value comprises:
calling a preset callback function to convert the pose data into a target game coordinate;
obtaining a current game coordinate of the game object based on the callback function; and
calculating the target offset value based on the target game coordinate, the current game coordinate, and a preset scaling ratio.

19. The computer-readable storage medium of claim 18, wherein the pose data comprises three-axis gyroscope data and three-axis acceleration data, and x-axis data and y-axis data of the three-axis gyroscope data and the three-axis acceleration data is used to calculate the target game coordinate.

20. The computer-readable storage medium of claim 19, wherein
the preset translation action determination model is constructed and trained based on a logistic regression algorithm,
wherein an objective function for the preset translation action determination model is as follows:
$${h}_{W} ( x ) = g ( {W}^{T} x ) = \frac{I}{I + {e}^{- {w}^{T} x}} ,$$
wherein h_{W}(x) outputs a probability that a current offset value meets a preset criterion, x=(x₀, x₁, . . . , xₙ) is an argument representing an offset value, and w^{T}=(w₀, w₁, . . . , wₙ)^{T} represents a parameter for the argument x, where n represents an integer greater than 1; and
a loss function for the preset translation action determination model is as follows:
J_{log}(w)=Σᵢ₌₁^{m}−yᵢ log(p(xᵢ;w))−(1−yᵢ)Log(1−p(xᵢ;w)),
wherein p(xᵢ;w) represents a probability that the argument xᵢ is predicted to be positive, 1−p(xᵢ;w) represents a probability that the argument xᵢ is predicted to be negative, m indicates a number of samples of the argument x, and yᵢ indicates a value of the argument xᵢ in a y-axis of a two-dimensional plane.
